(19) United States
(12) Patent Application Publication
(10) Pub. No.: US 2009/0125654 A1
(43) Pub. Date: May 14, 2009

(54) KVM Switch

(76) Inventor: Tony Lou, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/938,294

(22) Filed: Nov. 12, 2007

(51) Int. Cl. G06F 13/00

(52) U.S. Cl. 710/73

(57) ABSTRACT

A KVM switch which allows a far end console and a near end console to share a single bus is provided. The KVM switch includes a host port, a far end port, a near end port, a video processing module, a far end video processing module, a video switching module, an operation processing module, a far end operation signal module. In order to share the single bus, an additional far end video processing module transmits display signals from the host port to the far end console via the far end port, or displays display signals on a monitor via the video processing module. At the same time, an additional far end operation signal module receives an operation signal from the far end console via the far end port, or transmits the operation signal from an operation device to the host computer via the operation processing module.

### BACKGROUND OF THE INVENTION

1. Field of the Invention

The present invention relates generally to a KVM switch (with KVM being an abbreviation for Keyboard, Video, Mouse) that is a hardware device that allows a user to control multiple computers from a single keyboard, video output device and mouse, and in particular, to a KVM switch adapted for a single bus shared by a near end console and a far end console.

2. The Prior Arts

More and more computers are grouped for dealing with complicated, heavy tasks. Management of the computers is required to be convenient, centralized, efficient, and safe. According to such demands, KVM products are being developed and marketed.

A KVM switching system is a management equipment for managing a computer group which is consisted of a plurality of host computers. In a KVM switching system, a KVM switch adaptively arranges and connects a keyboard, a mouse and a video output device between different host computers, so as to be capable of diminishing the demand of surplus keyboards, monitors, and mice, and thus saving room and power consumption. In the meantime, operation and management of the computer room can be simplified, and maintenance efficiency, safety and reliability of the management can be improved.

In a conventional KVM switch, electrical cables connected between a console, which is also known as a user's operation terminal, a plurality of calculation device terminal, such as personal computers, are adapted for transmitting video signals for displaying images on a display device, and control signals generated from input devices such as a keyboard, and a mouse. In such a way, when a user operates the KVM switch to switch to a certain calculation device terminal, he is then capable of viewing the image corresponding to the transmitted video signals of the certain calculation device terminal from the display device, as well as remotely operating the certain calculation device terminal via the keyboard and the mouse.

In order to allow the consoles and the calculation device terminal workable when being apart from a longer distance, the foregoing electrical cables can be CAT5 cables while the KVM switch adopts a corresponding conversion system for conversion. In such a CAT5 KVM switch, a universal asynchronous receiver/transmitter (UART) is employed for communicating keyboard signals, mouse signals, status signals, and control signals with the console including a single main box, the calculation device terminal including a dongle, respectively.

A typical console structure is often one-to-one corresponding, in which a single channel bus corresponds to a single console or a plurality of channel buses correspond to a plurality of consoles (multiple-to-multiple mode). The former includes only one console interface, and the console is either disposed together with the main box at the console side, or there is no console function at the far end or the near end. Although cheap, but this is apparently inconvenient.

As such, there are already many multiple-to-multiple products developed in accordance with the demand for multiple-to-multiple mode. However, the current multiple-to-multiple products are only about the mode of multiple channels corresponding to multiple consoles, such as a switch for corresponding 2 consoles to 16 host computers. Such a switch allows a plurality of users to operate at a same time. However, because of the employment of multiple channels, the cost thereof is very high, especially VGA channels which are more expensive as adopting matrix structures therein. Further, the current multiple-to-multiple switch is either designed for a far end console, or a near end console. There is no combination type of far end console and near end console developed yet.

But, in many times, the user may require both a far end console and a near end, which cannot be satisfied by the foregoing products. For example, in routine operation, when the hardware is inspected from the far end via the far end console, a near end operation is also desired. Therefore, only one console does not satisfy the practical demands.

Although IP KVM products are adapted for far end/near end combining operation, these products introduce extra components for network communication as well as the cost thereof. Accordingly, the present invention is provided for improving the conventional KVM products, and provides a KVM switch which allows a far end console and a near end console to share a single bus, so as to allow the near end console and the far end console for operating simultaneously.

### SUMMARY OF THE INVENTION

A primary objective of the present invention is to provide a KVM switch which allows a far end console and a near end console to share a single bus. The near end console and the far end console, sharing the single bus, are adapted to be selected by the KVM switch to control at least one host computer.

According to the foregoing objective, the present invention provides a KVM switch. The KVM switch includes a host port, a far end port, a near end port, a video processing module, a far end video processing module, a video switching module, an operation processing module, a far end operation signal module. In order to share the single bus, an additional far end video processing module, in accordance with requirement of far end operation or near end operation, transmits display signals from the host port to the far end console via the far end port, or displays display signals on a monitor via the video processing module. At the same time, an additional far end operation signal module receives an operation signal from the far end console via the far end port, or transmits the operation signal from an operation device to the host computer via the operation processing module.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a KVM switch switching between a far end console and a near end console;

FIGS. 2A and 2B are schematic diagrams illustrating a KVM switch in accordance with an embodiment of the present invention; and

FIG. 3 is another schematic diagram illustrating the KVM switch switching between a far end console and a near end console.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

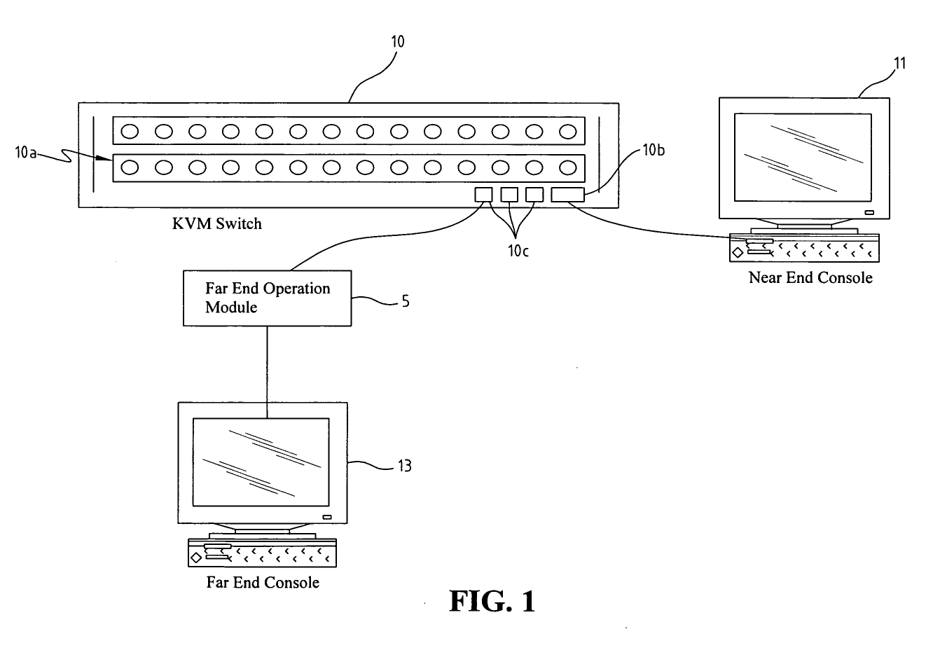

FIG. 1 is a schematic diagram illustrating a KVM switch switching between a far end console and a near end console. Referring to FIG. 1, a KVM switch 10 includes a plurality of host ports 10a, a near end port 10b, and at least one far end port 10c. The host ports 10a are adapted for electrically connecting a host computer. The KVM switch 10 is electrically connected with a near end console 11 from the near end port 10b by a cable. The KVM switch 10 is electrically connected to a far end console 13 from the far end port 10c via a far end operation module 5, i.e., a conventional KVM switch.

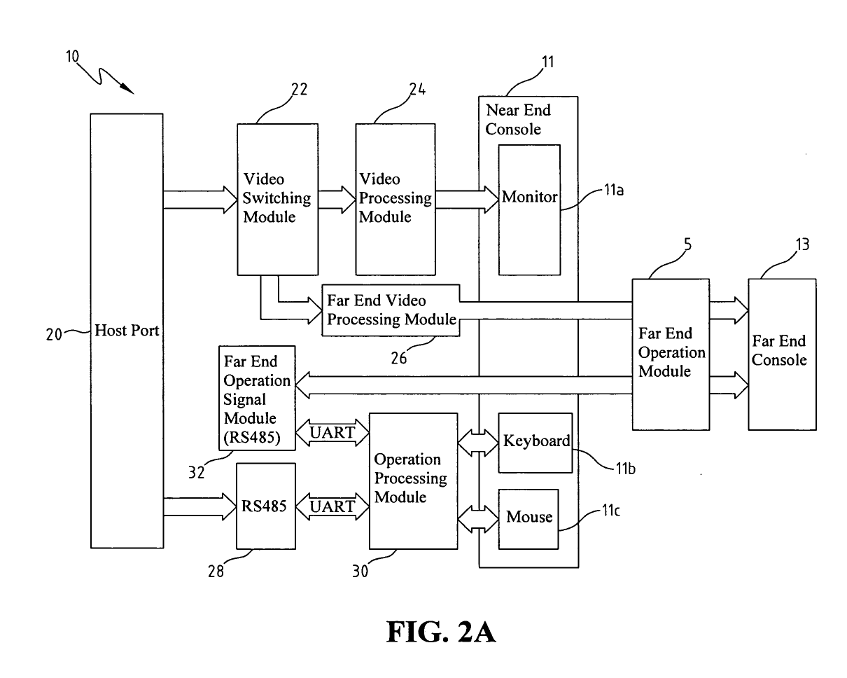

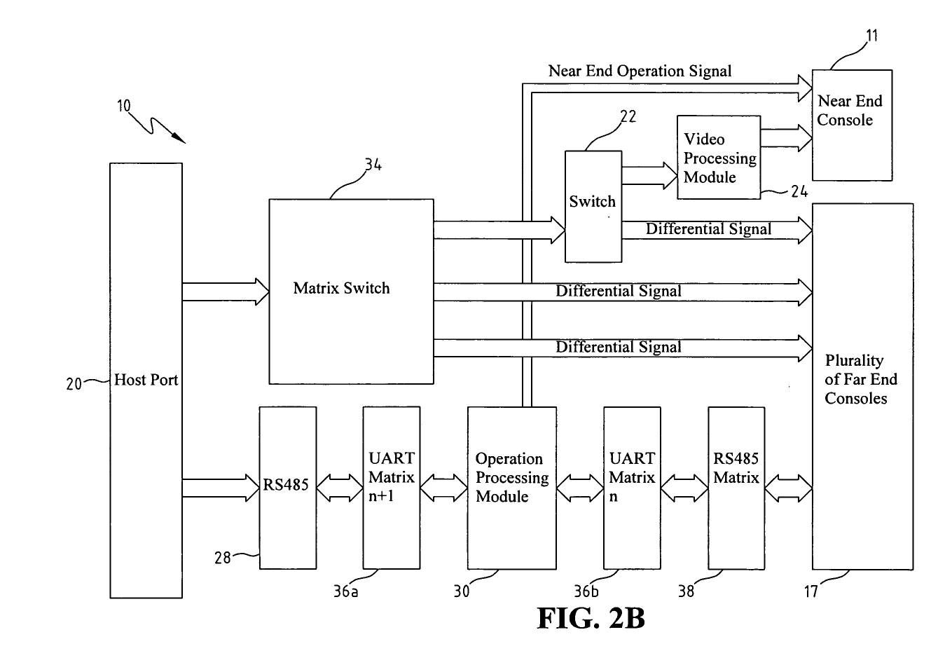

FIGS. 2A and 2B are schematic diagrams illustrating a KVM switch in accordance with an embodiment of the present invention, in which FIG. 2A illustrates a one-to-one KVM switch 10, and FIG. 2B illustrates a multiple-to-multiple KVM switch 10.

As shown in FIG. 2A, the KVM switch 10 is adapted for allowing the near end console 11 and the far end console 13 to share a single bus, so as to be selected to control at least one host computer. The KVM switch 10 includes a host port 20, a near end port 10b, a far end port 10c, a video processing module 24, a far end video processing module 26, a video switching module 22, an operation processing module 30, and a far end operation signal module 32.

In general, in order to share the single bus, comparing with FIG. 1, the KVM switch 10 as shown in FIG. 2 further includes a video switching module 22, a far end video processing module 26 in addition. The additional video switching module 22 and the additional far end video processing module 26 are adapted for shunting images signals transmitting to the video processing module 24. According to an aspect of the embodiment, the KVM switch 10 further includes a far end operation signal module 32 in addition for shunting and processing the operation signal. In such a way, in accordance with requirement of far end operation or near end operation, the KVM switch 10 transmits display signals from the host port 20 (or the host computer) in a form of the shunted display signal (the additional video switching module 22 and the additional far end video processing module 26) as described above to the far end console 13 via the far end port 10c, or displays the display signals on a monitor 11a via the video processing module 24. At the same time, the additional far end operation signal module 32 receives an operation signal from the far end console 13 via the far end port 10c, or transmits the operation signal from an operation device, e.g., a keyboard 11b or a mouse 11c, to the host computer via the operation processing module 30.

For example, when it is needed to operate the host computer by the far end console 13, the video switching module 22 transfers the display signal from the host port 20 to the far end video processing module 26, and the far end video processing module 26 then transmits the display signal to the far end console 13. As the far end console 13 receives the display signal, the far end console 13 then displays a corresponding image on a monitor thereof. According to an aspect of the embodiment, the video processing module 24 is adapted to recover the display signal transmitted from the host port 20 from a differential signal to a RGB signal, and the RGB signal is compensated for driving the monitor 11a.

When the user tries to use the mouse 11c to open a file catalog in the host computer, the far end console 13 generates a corresponding operation signal to the KVM switch 10. Then, when the far end operation signal module 32 receives the operation signal generated from the far end console 13 via the far end port 10c, the operation signal is transferred to the host computer via the operation processing module 30 for practically performing the procedure of opening the file catalog. According to an aspect of the embodiment, the far end operation signal module 32 for example is a RS485 chip, communicating with the operation processing module 30 via an UART interface. The operation processing module 30 transfers the operation signal to the host computer via a RS485 chip, and the operation processing module 30 communicates with the RS485 chip via the UART interface.

Otherwise, when the near end console 11 is needed for operating the host computer, the video switching module 22 of the KVM switch 10 in accordance with the present invention transfers a display signal transmitted from the host port 20 to the video processing module 24, and the video processing module 24 then displays the display signal on the monitor 11a via the near end port 10b. When the user intends to use the mouse 11c to open the file catalog of the host computer according to the image he viewed, an operation signal is then generated correspondingly. Then the operation signal is received by the operation processing module 30 via the near end port 10b and transferred to the host computer to practically perform the procedure of opening the file catalog.

Further, it should be noted that the far end operation module 5 provided for the far end console 13 for receiving the display signal and emitting the operation signal is a conventional KVM switch, which is generally similar to the KVM switch 10 of the present invention. However, the far end operation module 5 lacks the video switching module 22, the far end video processing module 26, and the far end operation signal module 32. In this manner, the far end operation module 5 receives the display signal and emits the operation signal like the near end console 11 does.

As to the multiple-to-multiple mode, it can be learnt from the foregoing teaching and by further referring to FIG. 2B. As shown in FIG. 2B, as for the operation signal, the operation processing module 30 communicates via a plurality of UART interfaces 36a, 36b with a plurality of host computers and a plurality of far end ports, i.e., a plurality of far end consoles 17 via a RS485 matrix 38. As for the display signal, a matrix switch 34 is employed for realizing the multiple-to-multiple mode.

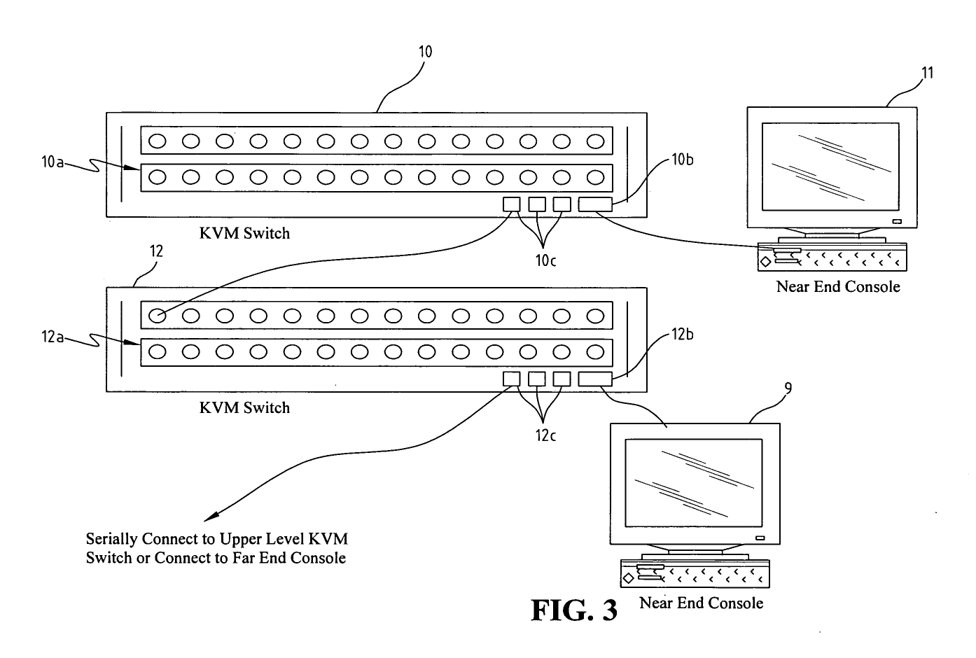

Referring to FIG. 3, there is shown another schematic diagram illustrating the KVM switch switching between a far end console and a near end console. As shown in FIG. 3, a first KVM switch 10 is electrically connected to a second KVM switch 12. The first KVM switch 10 includes a plurality of host ports 10a, a near end port 10b, and at least one far end 10c. Similarly, the second KVM switch 12 includes a plurality of host ports 12a, a near end port 12b, and at least one far end 12c.

According to the current embodiment and referring to FIG. 3, because signals outputted from the far end ports 10c, 12c remain unchanged, and thus are equal to signals emitted from the host computer. As such, the KVM switches 10 and 12 adapted for different host computers can be electrically serially connected by the far end port 10c and the host port 12a.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A KVM switch, connected to a far end console and a near end console, the KVM switch being adapted for allowing the far end console and the near end console to share a single bus, so that the far end console and the near end console can be selected for controlling at least one host computer, each of the far end console and the near end console comprising a monitor and an operation device, the KVM switch comprising:
a host port, adapted for being electrically connected to a host computer via an electrical cable;
a far end port, adapted for being electrically connected to the far end console via an electrical cable;
a video processing module, for displaying a display signal transmitted from the host port at one of the monitors;
a far end video processing module, for transmitting the display signal transmitted from the host port to the far end console via the far end port;
a video switching module, electrically connected to the host port, the display processing module, and the far end video processing module, for transferring the display signal transmitted from the host port to the display processing module or the far end video processing module;
a far end operation signal module, for receiving an operation signal from the far end console via the far end port; and
an operation processing module, for transferring the operation signal transmitted from the operation device or the far end operation signal module to the host computer.

2. The KVM switch according to claim 1, wherein the operation device comprises a keyboard and/or a mouse.

3. The KVM switch according to claim 1, wherein the video processing module recovers the display signal transmitted from the host port from a differential signal form to a RGB signal, and compensates the RGB signal for driving the monitor.

4. The KVM switch according to claim 1, wherein the far end operation signal module is a RS485 chip communicating with the operation processing module via an UART interface.

5. The KVM switch according to claim 1, wherein the operation processing module transfers the operation signal to the host computer via a RS485 chip, and the operation processing module communicates with the RS485 chip via an UART interface.

6. The KVM switch according to claim 1, wherein the operation processing module is adapted to communicate via a plurality of UART interfaces with a plurality of host computers, a plurality of far end ports.

7. The KVM switch according to claim 1, wherein the signals inputted/outputted from the far end ports are equal to signals inputted/emitted from the host computer, and different host computers are electrically serially connected by the far end port and the host port.
